(19) United States
(12) Patent Application Publication
(10) Pub. No.: US 2007/0168416 A1
(43) Pub. Date: Jul. 19, 2007

(54) Controlling autonomous message transmission

(76) Inventor: Sung-Hoon Lim, Suwon-si (KR)

Correspondence Address: Robert E. Bushnell, Suite 300, 1522 K Street, N.W., Washington, DC, 20005-1202, US

(21) Appl. No.: 11/640,900

(22) Filed: Dec. 19, 2006

(30) Foreign Application Priority Data
Jan. 19, 2006 (KR) 10-2006-0005804

(51) Int. Cl. G06F 15/16

(52) U.S. Cl. 709/203

(57) ABSTRACT

In an autonomous message transmission control system and method, a network management system including a management server stores whether an autonomous message is allowed to be received by at least one management client connected to a network element transmitting the autonomous message corresponding to a predetermined event when the event occurs. The network element transmits the autonomous message only to the management client permitted receipt of the autonomous message upon receipt of the autonomous message from the network element. Accordingly, when a generation inhibition command is issued on a specific autonomous message by an arbitrary management client, other management clients can actively select whether receipt of the autonomous message is permitted, so that more convenient and safer network management can be implemented.

### CLAIM OF PRIORITY

This application makes reference to, incorporates the same herein, and claims all benefits accruing under 35 U.S.C. §119 from an application for APPARATUS AND METHOD FOR CONTROL OF AUTONOMOUS MESSAGE TRANSMISSION earlier filed in the Korean Intellectual Property Office on the 19 Jan. 2006 and there duly assigned Serial No. 10-2006-0005804.

### BACKGROUND OF THE INVENTION

1. Field of the Invention

The present invention relates to an apparatus and method for controlling autonomous message transmission using a Transaction Line 1 (TL1), Simple Network Management Protocol (SNMP), etc.

2. Description of the Related Art

The information infrastructures of many business environments nowadays are built using large-scale networks. Such large-scale networks include numerous Network Elements (NEs) such as routers, switches, and the like, and thus require considerable time and effort to manage. Accordingly, tools for effective network management are required. One such tool which is recently widely employed is a Network Management System (NMS). The NMS copes with physical obstacles of the NEs, and carries out control and checks on the NEs.

The NMS, in order to operate the network in a safe and effective way, carries out an integrated function including monitoring, controlling, and managing routers, switches, hubs, servers, and so forth used for communication service in the network. The NMS is generally configured based on a personal computer (PC) or a Workstation, and monitors and controls the NEs that need to be managed using network management protocol. That is, the NMS communicates with the NEs that need to be managed on the network to obtain a Management Information Base (MIB) of the NEs.

In a Network Management System (NMS), the NMS issues a command to a Network Element (NE), and the NE in turn responds to it and executes the command. The NE then notifies the NMS of the result of executing the command.

The NMS issues commands associated with functions including fault management, performance management, configuration management, security management, and so forth.

Fault management involves promptly notifying the network manager of a fault, analyzing information about the fault, and notifying the manager of how to deal with the fault for prompt recovery. Performance management involves checking a current or past status, usage, and load, of network resources to detect problems that might occur in the future. Configuration management involves delivering, to the manager, information about components such as protocols, topologies, and the like, as well as information about network components such as servers, clients, PCs, and the like, along with NEs. Security management involves preventing important data within the network from being used illegally and from being hacked into from outside.

The present invention is directed to a procedure of having NEs transmit autonomous messages to the NMS in real time in the network environment including various NEs and the NMS managing the NEs. In this case, the autonomous message indicates a message reporting Alarm, Fault, and Event defined by the Transaction Line 1 (TL1) standard.

One of several NMSs can stop transmission of the autonomous messages associated with the event occurring in the specific NE. In this case, the NE does not need to transmit the autonomous message to the other NMSs.

Inhibiting the autonomous message from being generated in the specific NE can cause a very serious situation in actual system operation. That is, the NMS may not be notified of the autonomous message generated in one NE, which could potentially halt network service or put the system in an unpredictable state.

### SUMMARY OF THE INVENTION

It is an objective of the present invention to provide a system and method for controlling autonomous message transmission, which, when an autonomous message is required to be generated, notify NMS clients of the status and transmit the autonomous message only to NMS client(s) permitting receipt of the autonomous message.

According to one aspect of the present invention, a Network Management System (NMS) is provided including: at least one NMS client adapted to carry out network management; a Network Element (NE) adapted to transmit an autonomous message corresponding to a predetermined event upon the event occurrence; and an NMS server adapted to store whether receipt of the autonomous message is permitted for each NMS client, and to transmit the autonomous message only to NMS clients permitted receipt of the autonomous message upon receipt of the autonomous message from the NE.

The NMS server preferably includes: a database adapted to store whether receipt of the autonomous message is permitted for each NMS client; and an autonomous message processing module adapted to retrieve the NMS clients permitted receipt of the autonomous message from the database, and to transmit the autonomous message to the retrieved NMS clients.

The autonomous message processing module is preferably adapted to extract at least one message characteristic from a code, a severity, and an autonomous message generation element, of the received autonomous message, and to retrieve the NMS clients permitted receipt of the autonomous message having the extracted message characteristic from the database.

The NMS server preferably further includes a client management module adapted to update whether the autonomous message stored in the database has been received by a first NMS client upon receiving a local autonomous message transmission control command from the first NMS client.

The NE preferably includes an autonomous message event control module adapted to transmit an autonomous message control event to the NMS server, the autonomous message control event requesting the NMS server to query whether a predetermined autonomous message has been received for each NMS client belonging to the network and to obtain a response to the query.

The NMS server preferably further includes a client management module adapted to query whether the predetermined autonomous message has been received for each NMS client belonging to the network, and to update whether receipt of the autonomous message stored in the database is permitted for each NMS client according to the response to the query. The NMS server preferably further includes an account management module adapted to add, modify, and erase an account of the NMS client controlled by the NMS server.

According to another aspect of the present invention, a Network Management System (NMS) client is provided including: an interface adapted to display network resource status information, and to receive a control command from a network manager; an autonomous message display module adapted to control the interface to display an autonomous message upon receiving the autonomous message from an NMS server; and an autonomous message control event module adapted to receive whether receipt of a predetermined autonomous message is permitted from the network manager upon receiving the predetermined autonomous message control event from the NMS server, and to respond to the NMS server with the received result.

According to still another aspect of the present invention, a Network Management System (NMS) server is provided including: a database adapted to store whether an autonomous message is to be received for at least one NMS client belonging to a network; and an autonomous message processing module adapted to retrieve the NMS client permitted receipt of the autonomous message transmitted from a Network Element (NE) from the database, and to transmit the autonomous message only to the retrieved NMS client.

The NMS server preferably further includes a client management module adapted to update whether an autonomous message stored in the database is to be received by the first NMS client upon receiving a local autonomous message transmission control command from a first NMS client.

The NMS server preferably further includes a client management module adapted to query whether a predetermined autonomous message is to be received for each NMS client belonging to the network, and to update whether the autonomous message is to be received for each NMS client in accordance with a response to the query.

The client management module is preferably adapted to query whether the autonomous message is to be received for each NMS client belonging to the network upon receiving an autonomous message control event from either the NE or an NMS client belonging to the network.

According to yet another aspect of the present invention, a Network Element (NE), is provided including: an autonomous message generation module adapted to transmit an autonomous message corresponding to a predetermined event to a Network Management System (NMS) server upon the event occurring; and an autonomous message event control module adapted to transmit an autonomous message control event to the NMS server, the autonomous message event querying whether the predetermined autonomous message is to be received for each NMS client belonging to the network and getting a response to the query.

According to a further aspect of the present invention, a network management method is provided including: a Network Management System (NMS) server storing in a database whether an autonomous message is to be received for at least one NMS client belonging to a network; a Network Element (NE)transmitting the autonomous message corresponding to a predetermined event to the NMS server upon the event occurring; and the NMS server receiving the autonomous message, retrieving the NMS clients permitted receipt of the autonomous message from the database, and transmitting the autonomous message to the retrieved NMS clients.

The network management method preferably further includes the NMS server updating whether the autonomous message stored in the database is to be received by a first NMS client upon receiving a local autonomous message transmission control command from the first NMS client.

The network management method preferably further includes: the NMS server querying whether the autonomous message is to be received for each NMS client upon receiving a predetermined autonomous message control event; and receiving a response to the query from each NMS client, and updating whether the autonomous message stored in the database is to be received for each NMS client based on the response.

The NMS server preferably queries whether a predetermined autonomous message is to be received for each NMS client belonging to the network upon receiving an autonomous message control event from either the NE or an NMS client belonging to the network.

Retrieving the management client permitted receipt of the autonomous message preferably includes: extracting at least one message characteristic from a code, a severity, and an autonomous message generation element, of the received autonomous message; and retrieving the NMS clients allowed the extracted message characteristic to be received in the database for each message characteristic.

### BRIEF DESCRIPTION OF THE DRAWINGS

A more complete appreciation of the present invention and many of the attendant advantages thereof, will be readily apparent as the present invention becomes better understood by reference to the following detailed description when considered in conjunction with the accompanying drawings in which like reference symbols indicate the same or similar components, wherein:

FIG. 1 is a block diagram of general operations of a Network Management System (NMS);

FIG. 2 is a block diagram of a configuration of a network to which a network management method is applied in accordance with an exemplary embodiment of the present invention;

FIG. 3 is a flowchart of a local option autonomous message control method in accordance with another exemplary embodiment of the present invention;

FIG. 4 is a flowchart of a method of controlling global option autonomous message transmission in accordance with another embodiment of the present invention;

FIG. 5 is a flowchart of a method of controlling autonomous message transmission in accordance with another exemplary embodiment of the present invention;

FIG. 6 is a block diagram of an internal configuration of an NMS server in accordance with yet another exemplary embodiment of the present invention;

FIG. 7 is a block diagram of an internal configuration of a Network Element (NE) in accordance with yet another exemplary embodiment of the present invention;

FIG. 8 is a block diagram of an internal configuration of an NMS client in accordance with yet another embodiment of the present invention;

FIG. 9 is a view of a Graphic User Interface (GUI) of an NMS client in accordance with another exemplary embodiment of the present invention;

FIG. 10 is a view of a message input window delivering autonomous message generation inhibition in accordance with yet another exemplary embodiment of the present invention; and

FIG. 11 is a view of a message output window of autonomous message generation inhibition in accordance with yet another exemplary embodiment of the present invention.

### DETAILED DESCRIPTION OF THE INVENTION

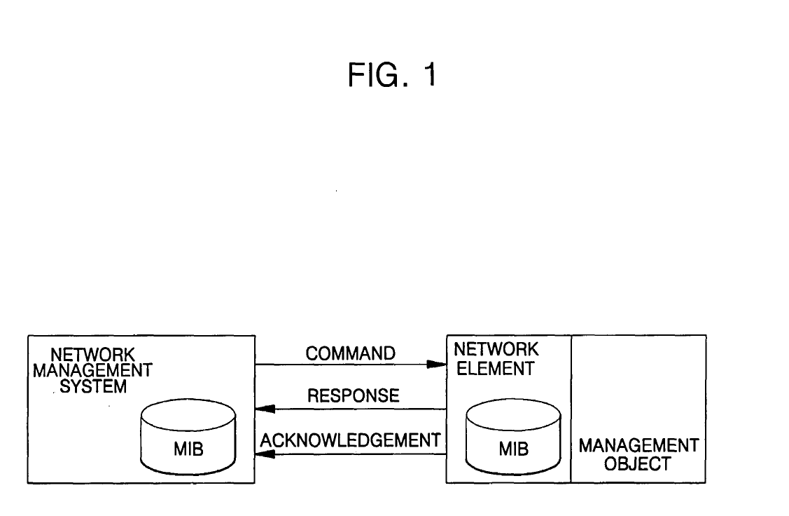

FIG. 1 is a block diagram of operations of a Network Management System (NMS).

As shown in FIG. 1, the NMS issues a command to a Network Element (NE), and the NE in turn responds to it and executes the command. The NE then notifies the NMS of the result of executing the command.

The NMS issues commands associated with functions including fault management, performance management, configuration management, security management, and so forth.

Fault management involves promptly notifying the network manager of a fault, analyzing information about the fault, and notifying the manager of how to deal with the fault for prompt recovery. Performance management involves checking a current or past status, usage, and load, of network resources to detect problems that might occur in the future. Configuration management involves delivering, to the manager, information about components such as protocols, topologies, and the like, as well as information about network components such as servers, clients, PCs, and the like, along with NEs. Security management involves preventing important data within the network from being used illegally and from being hacked into from outside.

The present invention is directed to a procedure of having NEs transmit autonomous messages to the NMS in real time in the network environment including various NEs and the NMS managing the NEs. In this case, the autonomous message indicates a message reporting Alarm, Fault, and Event defined by the Transaction Line 1 (TL1) standard.

One of several NMSs can stop transmission of the autonomous messages associated with the event occurring in the specific NE. In this case, the NE does not need to transmit the autonomous message to the other NMSs.

Inhibiting the autonomous message from being generated in the specific NE can cause a very serious situation in actual system operation. That is, the NMS may not be notified of the autonomous message generated in one NE, which could potentially halt network service or put the system in an unpredictable state.

Hereinafter, a system and method for controlling autonomous message transmission according to the present invention is described with reference to the accompanying drawings.

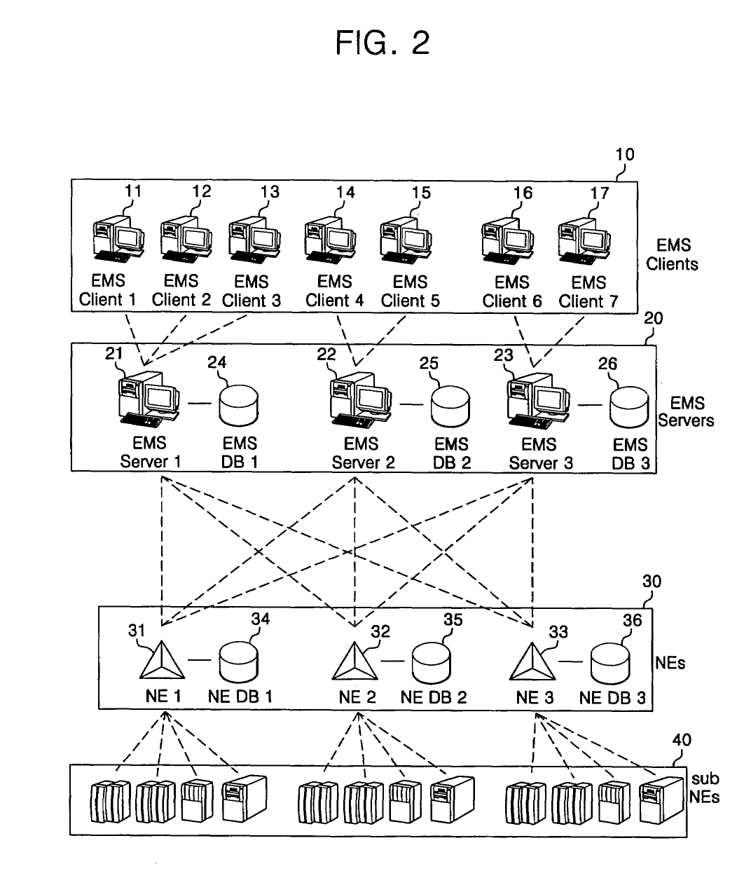

FIG. 2 is a block diagram of a configuration of a network to which a network management method according to an exemplary embodiment of the present invention is applied.

As shown in FIG. 2, the network according to the present invention includes an NMS client 10, an NMS server 20, an NMS database contained in the NMS server, an NE 30, and a sub NE 40.

The NMS client 10 receives autonomous messages from the NMS servers 20 and displays them to a network manager using a device such as a Graphic User Interface (GUI). The network manager can use the GUI of the NMS client 10 to issue a local option or a global option autonomous message transmission control command.

The NMS server 20 receives the autonomous message of each network element 30 registered by itself, stores the message in its own databases 24, 25, and 26, and transmits the message to the NMS client 10. The databases 24, 25, and 26 of the NMS server 20 store whether the autonomous message is to be received for each NMS client 10 in this embodiment of the present invention. The NMS server 20 uses such information to transmit the autonomous message only to the NMS client 10 allowed a predetermined autonomous message to be received.

The NE 30 receives autonomous messages of the sub NEs 40 connected to the NEs to store them in its own databases 34, 35, and 36 while transmitting them to the connected NMS server 20. The NE 30, upon receipt of a global option transmission control command, transmits an autonomous message inhibition event to respective NMS clients 10 using the NMS server 20.

The sub NE 40 is a sub element connected to and controlled by the NE 30. Even when the autonomous message transmission event is generated by the sub NE 40, it can be transmitted to the NMS clients 10 via the NE 30 in the same manner. Hereinafter, a method of controlling autonomous message transmission using the above-described components is described.

Control of autonomous message transmission in the present invention refers to allowing or forbidding a predetermined autonomous message to be received by each NMS client 10. For example, the first NMS client 11 can issue an autonomous message inhibition command or an autonomous message receiving command as a 500 code.

In addition, the NMS client can issue a local option or global option autonomous message control command. A method of controlling autonomous message transmission according to each option is described below.

The local option autonomous message control command is applied only to the NMS client 10 issuing the command. For example, when the first NMS client 11 issues a local option specific autonomous message inhibition command, the corresponding autonomous message is not transmitted to the first NMS client 11. The autonomous message is of course transmitted to the other NMS clients 12 and 13. Such a local autonomous message control command is used when a network manager inhibits receipt of an autonomous message that the manager does not need to check.

The global option autonomous message control command can be applied to all NMS clients 10 belonging to the network as well as the EMS client 10 issuing the command. When the NMS client 10 issues the specific global option autonomous message control command, it asks each NMS client 10 whether the corresponding autonomous message is inhibited from being received. The corresponding autonomous message is not transmitted to NMS client(s) 10 that respond to inhibit the autonomous message from being received. Hereinafter, an autonomous message control method is described with reference to specific examples.

As shown in FIG. 2, there are three NMS servers 21, 22, and 23 constituting the NMS server 20, which respectively register and manage NEs 1, 2, and 3 (31, 32, and 33). The NMS server 20 stores autonomous messages in the databases of the NMS servers while transmitting the autonomous messages to the NMS client 10 when the autonomous messages are generated by the NEs 1, 2, and 3 (31, 32, 33).

For example, when the first NMS client 11 receives the command to inhibit the autonomous message having a 1440 code in a local option, such a command is transmitted to the first NMS server 21. The first NMS server 21 stores in its own database 24 the information that the first NMS client 11 does not want to receive the autonomous message having the 1440 code. The first NMS server 21 then refers to the database 24 to determine whether the autonomous message is to be transmitted when the first NMS server receives the autonomous message having the 1440 code from the second NE 32. Specifically, the first NMS server 21 does not transmit the autonomous message having the 1440 code to the first NMS client 11 but transmits the autonomous message only to the second and third NMS clients 12 and 13.

In the same way, each component of the NMS server 20 can receive the global option autonomous message inhibition command from the NMS client 10. For example, it is assumed that the first NMS client 11 inhibits the autonomous message having a 1670 code from being transmitted in the global option from the third NE 33. The first NMS server 21 delivers the global option autonomous message inhibition command to the third NE 33 to generate an autonomous message inhibition event. The reason that the autonomous message control command is transmitted to the third NE 33 lies in applying the command to the NMS clients 14 to 17 controlled by the second and third NMS servers 22 and 23 as well as the NMS clients 11, 12, and 13 controlled by the first NMS server 21.

The third NE 33 delivers the autonomous message inhibition event to the second to seventh NMS clients 12 to 17 via the first to third NMS servers 21, 22, and 23. The second to seventh NMS clients 12 to 17, which have received the event, receive information as to whether the autonomous message having the 1670 code is to be inhibited from being received from the network manager and deliver the status to the first to third NMS servers 21, 22, and 23. Each component of the NMS server 20 stores the status in its own database, and refers to it to selectively transmit the autonomous message when the autonomous message having the 1670 code is received from the third NE 33 in the future.

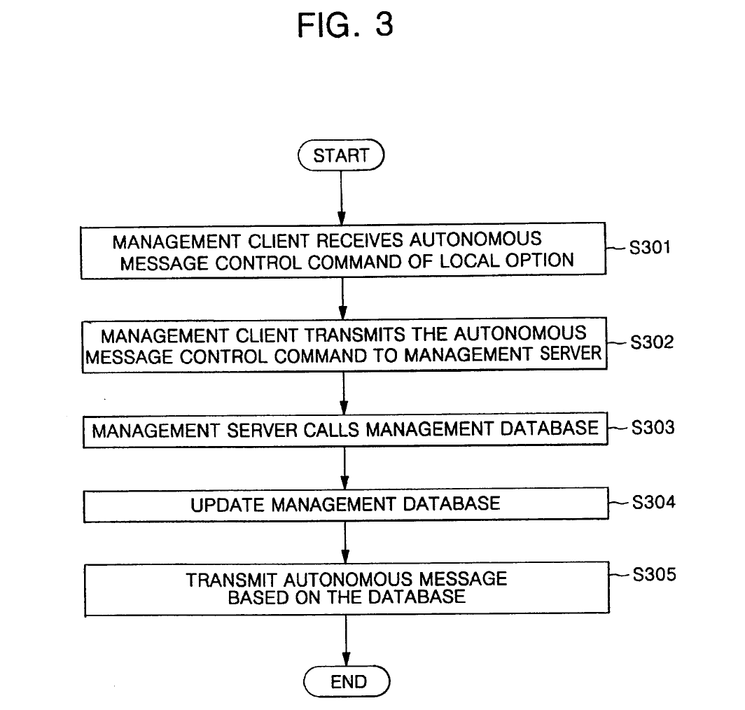

FIG. 3 is a flowchart of a local option autonomous message control method in accordance with another exemplary embodiment of the present invention.

The NMS client 10 receives the specific autonomous message control command of the NE in a local option from the network manager (S301). The network manager can receive the command through a GUI or a Command Line Interface (CLI).

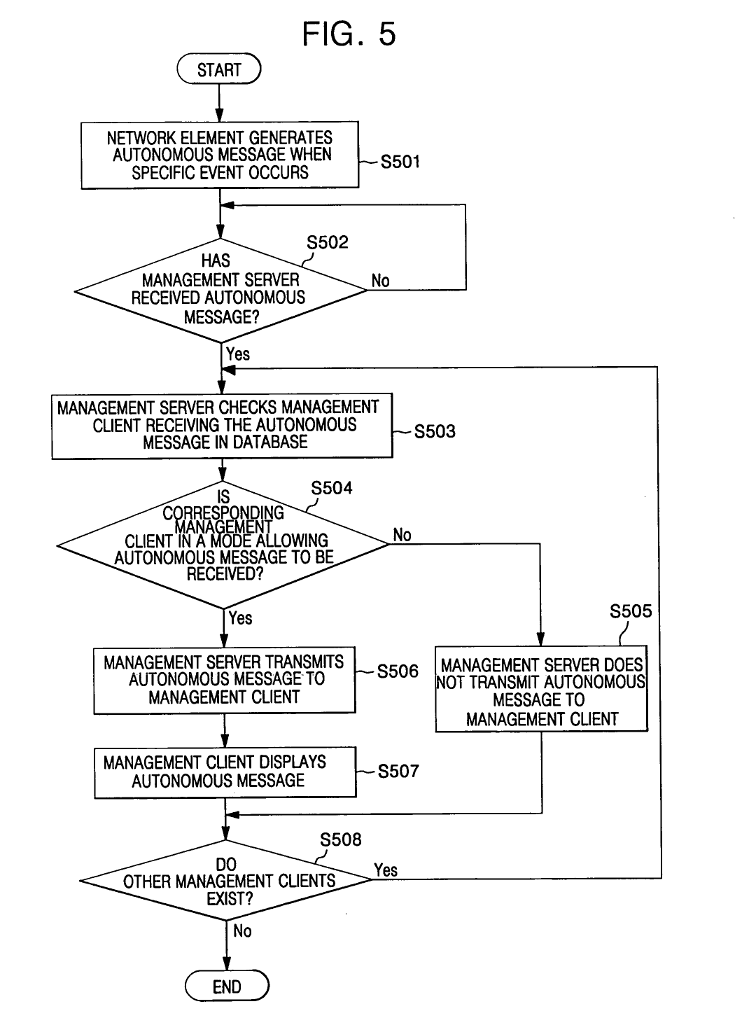

The NMS client 10 transmits the autonomous message transmission control command to the NMS server 20 that manages the NMS client 10 (S302). The NMS server 20 receives the generation inhibition command, and calls the MIB (S303). The NMS server 20 updates the information that the NMS client 10 receives the autonomous message or allows the autonomous event to be received in the called MIB (S304). The NMS server 20, upon receipt of the autonomous message from the NE 30, transmits the autonomous message using the updated MIB (S305). Step S305 is described in detail below with reference to FIG. 5.

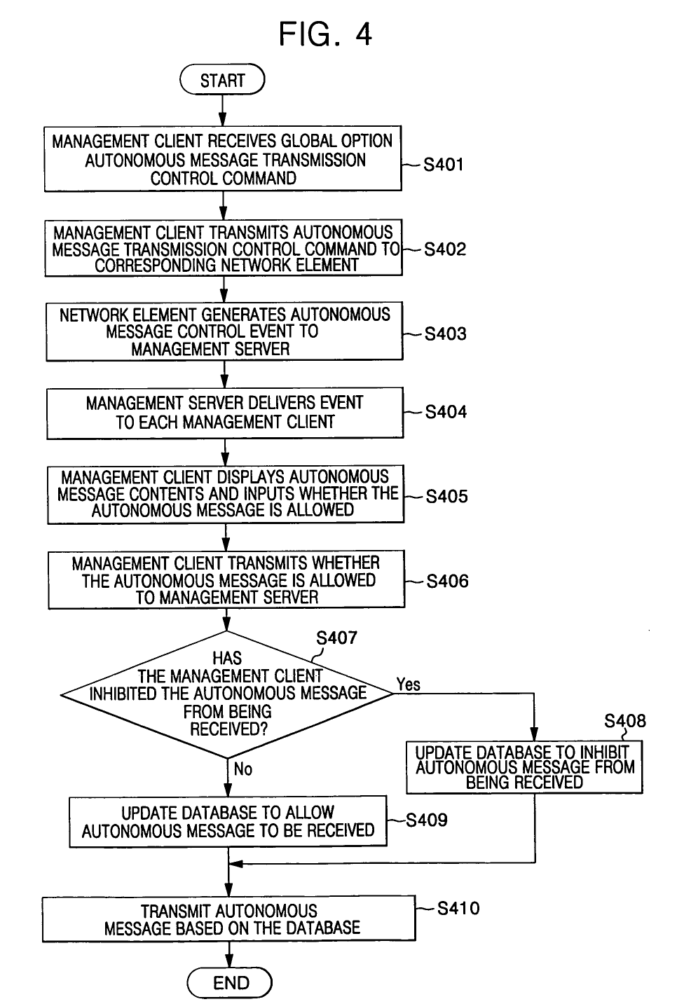

FIG. 4 is a flowchart of a method of controlling global option autonomous message transmission in accordance with another exemplary embodiment of the present invention.

An arbitrary NMS client 10 first receives the specific autonomous message transmission control command of the specific NE 30 in a global option from the network manager (S401). The NMS client 10 transmits the generation inhibition command to the corresponding NE 30 via the NMS server 20 (S402).

The corresponding NE 30 generates an autonomous message control event to all of the NMS servers 20 managing the NE 30 (S403). The NMS server 20, sensing the autonomous message control event, transmits the event to each NMS client 10 managed by the NMS server (S404).

The NMS client 10, receiving the event, displays the autonomous message control contents and receives information as to whether it is allowed to be received from the network manager (S405). Accordingly, the NMS client 10 transmits the status of whether the autonomous message control input from the network manager is allowed to the NMS server 20 (S406).

As described above, the method of controlling the autonomous message can be classified into issuing a command permitting receipt of the autonomous message and issuing a command to inhibit the autonomous message from being received. The NMS server 20 determines whether the NMS client 10 wants to inhibit the autonomous message from being received (S407).

When the network manager selects autonomous message inhibition, the NMS server 20 updates the autonomous message receiving status of the corresponding NMS client 10 to the inhibition status in the MIB (S408). In the same way, when the network manager selects allowance of receipt of the autonomous message, the NMS server 20 updates the autonomous message receiving status of the corresponding NMS client 10 to the allowed status in the MIB (S408).

The NMS server 20 transmits the autonomous message to each NMS client 10 in accordance with the updated information of the MIB (S410).

FIG. 5 is a flowchart of a method of controlling autonomous message transmission in accordance with another exemplary embodiment of the present invention.

The NE 30 generates an autonomous message when a specific event occurs in the sub NE 40 or the NE 30 (S501).

The NMS server 20 periodically checks whether an autonomous message has been transmitted from the NE 30 (S502). When an autonomous message has been received, the NMS server 20 checks the code of the autonomous message and retrieves the list of NMS clients 10 trying to receive the autonomous message (S503). That is, it checks the information as to whether the autonomous message of the NMS client 10 stored in accordance with the procedure of FIG. 3 or 4 is allowed (S504).

When the autonomous message is inhibited from being received by the NMS client 10, the NMS server 20 does not transmit the autonomous message that it has received to the NMS client 10 (S505).

Alternatively, when receipt of the autonomous message is permitted by the NMS client 10, the NMS server 20 transmits the autonomous message that it has received to the NMS client 10 (S506). Accordingly, the NMS client 10 receives the autonomous message and stores it in its own database while displaying it to the network manager (S507).

The NMS server 20 repeats the procedures of S503 to S507 on all NMS clients 10 managed by the server (S508). When selective transmission of the autonomous message is terminated on all NMS clients 10, the operation is ended.

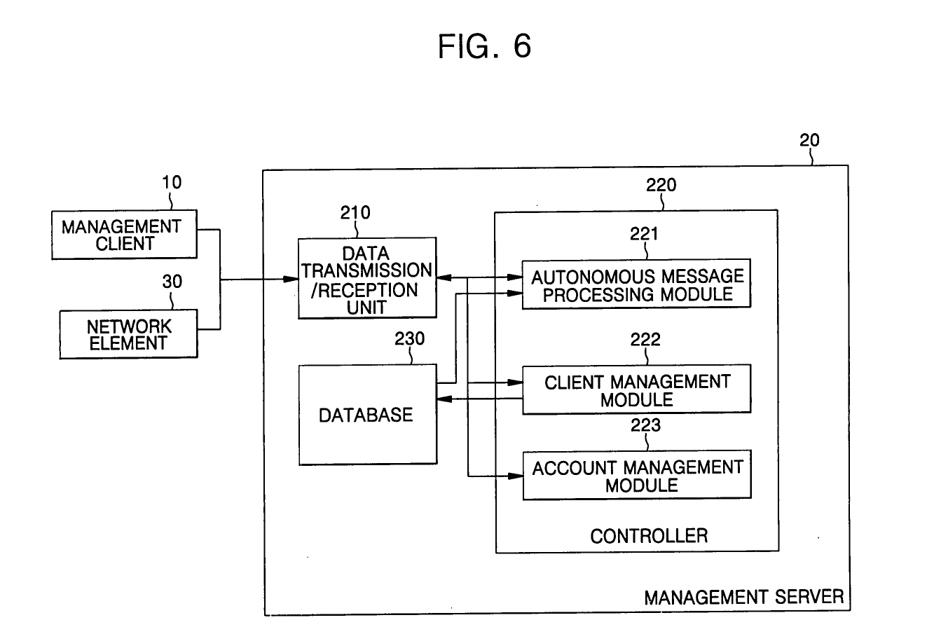

FIG. 6 is a block diagram of an internal configuration of a management server in accordance with yet another exemplary embodiment of the present invention.

As shown in FIG. 6, the NMS server 20 is composed of a data transmission/reception unit 210, a controller 220, and a database 230.

The data transmission/reception unit 210 communicates with the NMS client 10 or the NE 30. The data transmission/reception unit 210 enables data, such as an autonomous message, a command allowing the autonomous message, or a command to inhibit the autonomous message to be transmitted and received. Such data transmission/reception can be carried out using a protocol such as TL1 or SNMP.

The database 230 stores whether the autonomous message is to be received by the NMS client 10 belonging to the network. The database 230 stores whether the autonomous message is to be received by the NMS client 10 for each NMS client and each kind of autonomous message.

In this case, information management for each NMS client 10 refers to management of whether autonomous messages registered in the specific NMS clients 10 is to be received for each NMS client. In addition, information management for each kind of autonomous message refers to storing of whether specific autonomous messages are to be received for each NMS client 10 within the network when a specific autonomous message has been selected.

The controller 220 controls autonomous message transmission according to the present invention, and includes an autonomous message processing module 221, a client management module 222, and an account management module 223.

The autonomous message processing module 221, upon receipt of the autonomous message, determines to which NMS client 10 the autonomous message is to be transmitted. For example, when the autonomous message is received from the NE 30, the autonomous message processing module 221 extracts 1423 as an index of the autonomous message. The autonomous message processing module 221 uses the extracted index to search the database 230. As a result, when only the second and third NMS clients allow the autonomous message of the 1424 index to be received, the autonomous message processing module 221 transmits the autonomous message to only the second and third NMS clients.

The client management module 222 sets whether receipt of the autonomous message is permitted for each NMS client 10.

For example, when the first NMS client 11 issues a command to inhibit the autonomous message of 1500 code in a local option, the client management module 222 of the first NMS server 21 updates whether the autonomous message of 1500 code is to be received by the first NMS client 21 in the database 230.

In addition, when the fourth NMS client 14 issues a command to inhibit the autonomous message transmission of 1600 code in a global option, the command is transmitted to the NE 30. Accordingly, the first NMS server 21 receives an autonomous message control event from the NE 30. In this case, the client management module 222 transmits the autonomous message control event to the second and third NMS clients 12 and 13 managed by the client management module. The second and third NMS clients 12 and 13 receive information as to whether the autonomous message is to be received from the network manager and respond to the client management module 222. The client management module 222 updates the database 230 in accordance with the response.

The account management module 223 adds, modifies, and erases accounts of the NMS client 10 controlled by the NMS server. For example, when a connection request has been received from the fifth NMS client 15, which is not registered in the database, the account management module 223 of the second NMS server 22 carries out a procedure of registering the information of the fifth NMS client 15 in the database 230.

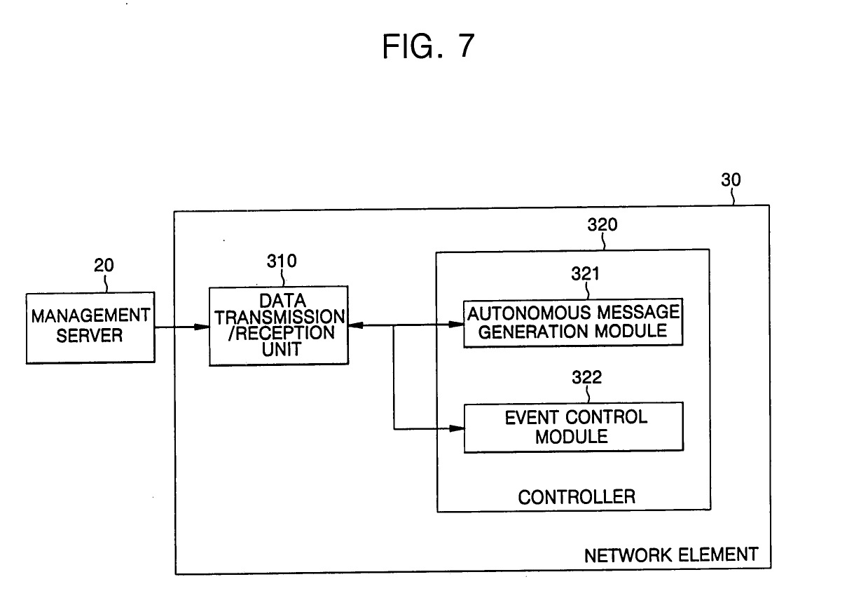

FIG. 7 is a block diagram of an NE in accordance with yet another exemplary embodiment of the present invention.

As shown in FIG. 7, the NE includes a data transmission/reception unit 310 and a controller 320 for applying the method of controlling autonomous message transmission in accordance with the present invention. The controller 320 includes an autonomous message generation module 321 and an event control module 322.

A global option autonomous message inhibition command is received from the NMS server 20. In this case, the autonomous message event control module 322 generates an autonomous message control event to transmit it to at least one of the NMS servers 20 managing the NE 30.

Even when such an autonomous message control event has been generated, the NE 30 generates the autonomous message in the same way as described above. The autonomous message generation module 321 of the NE 30 transmits the autonomous message to the NMS server 20 in the same way, and the NMS server 20 transmits the autonomous message only to the NMS client(s) 10 which allow(s) the message to be received in accordance with the information stored in the database 230.

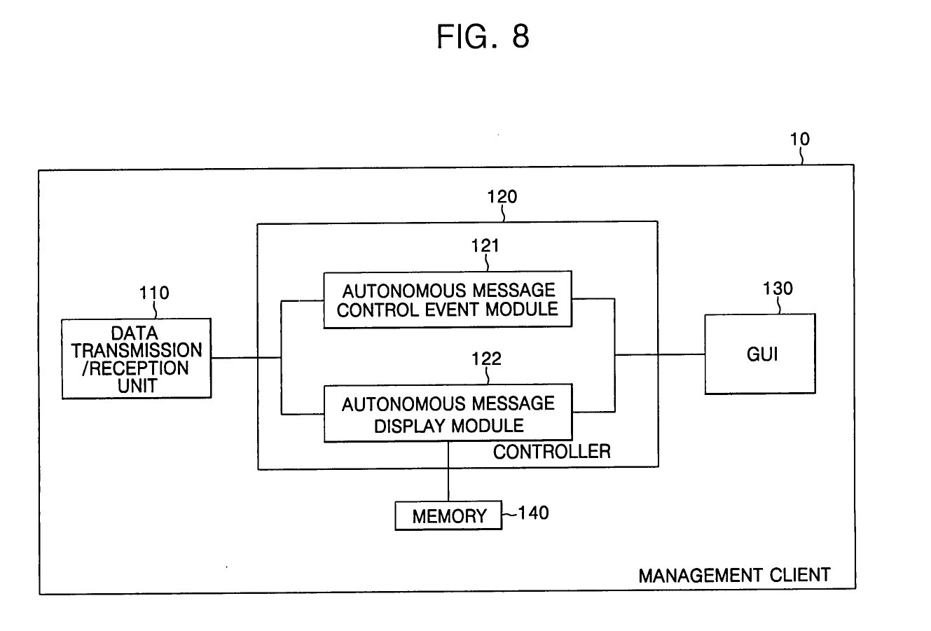

FIG. 8 is a block diagram of an NMS client in accordance with yet another exemplary embodiment of the present invention.

As shown in FIG. 8, the NMS client 10 includes a data transmission/reception unit 110, a controller 120, a GUI 130, and a memory 140. In this case, the data transmission/reception unit 110 corresponds to the NMS server 20 and the NE 30 for data communication.

The controller 120 includes an autonomous message control event module 121 and an autonomous message display module 122.

The autonomous message control event module 122, when the autonomous message control event has been transmitted from the NMS server 20, is in charge of controlling the same. In particular, it asks the network manager whether autonomous message transmission is allowed or inhibited using the GUI 130, and receives a response and transmits it to the NMS server 20.

The autonomous message display module 122, when the autonomous message has been transmitted to the NMS client, stores the autonomous message in the memory 140 while displaying it on the GUI 130.

The GUI 130 is an interface that allows the network manager to carry out the control method according to the present invention or inquire about the autonomous message. The network manager can also use other kinds of interfaces to manage the network. The GUI 130 is described in detail as follows.

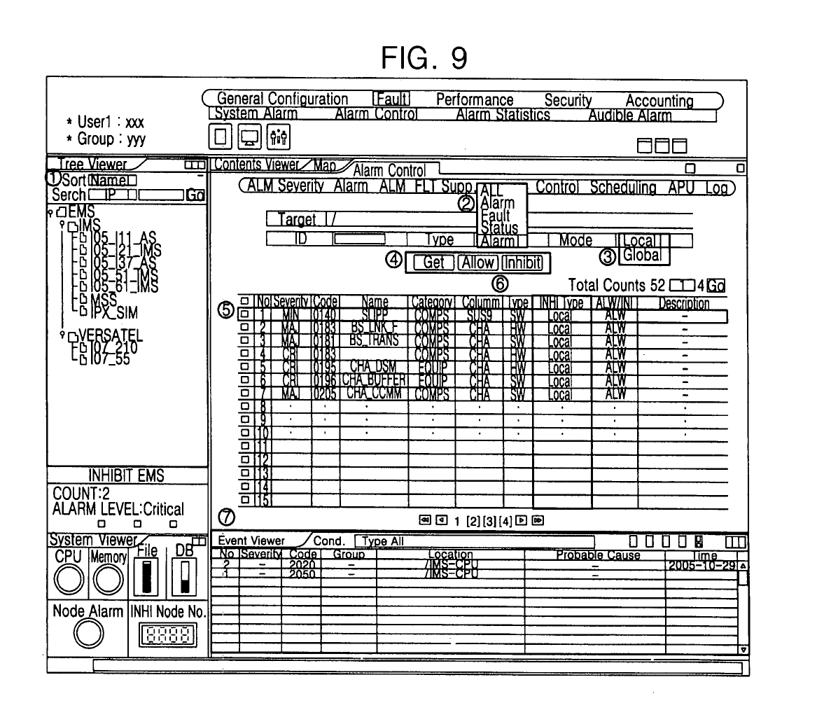

FIG. 9 is a view of a GUI of an NMS client in accordance with another exemplary embodiment of the present invention.

The network manager can operate the NMS client to control the entire network. The network manager can provide the GUI of FIG. 6 for controlling the network. The GUI of the NMS client can include seven main menus.

Menu No. 1 displays an NE that is presently being managed using a tree structure. The network manager can click the NE that is being displayed to select the NE that needs to be controlled.

The network manager can use menu No. 2 to select the kind of the autonomous message that needs to be controlled. When menu No. 2 is selected, sub menus including Alarm, Fault, and Status can be found. When the network manager is to control the autonomous message associated with errors, the Fault sub menu is selected.

Menu No. 3 enables an autonomous message option to be set. When the local option is selected in menu No. 3, the autonomous message is not only received by the NMS client. Alternatively, when the global option is selected in menu No. 3, all NMS clients managing the NE of interest selected from menu No. 1 determine whether the autonomous message generated by the NE is allowed.

Menu No. 4 can include Get, Allow, and Inhibit buttons. When the Get button is pressed, the information of the NE is fetched and displayed. In addition, when the Allow or Inhibit button is pressed, autonomous message transmission is allowed or inhibited in accordance with the options selected in menu Nos. 1, 2, and 3.

Menu Nos. 5 to 7 correspond to a region where the autonomous message information or the like is displayed. Menu No. 5 displays the type, allowed/inhibited status (ALW/INI), the category, the name, the severity, the code, and so forth, of the autonomous message with respect to the NE selected from menu No. 1. Menu No. 6 is a window where the autonomous message is allowed or inhibited in a local or global option. Menu No. 7 is a window where the autonomous message that has been received is displayed.

The network manager can use the above-described GUI to allow or inhibit the autonomous message generated by the specific NE. When the network manager selects the EMS group button of menu No. 1, the Alarm button of menu No. 2, the Local button of menu No. 3, and the Inhibit button of menu No. 4 as shown in FIG. 6, the Alarm autonomous message generated by the NE belonging to the EMS group is inhibited from being transmitted in the local option.

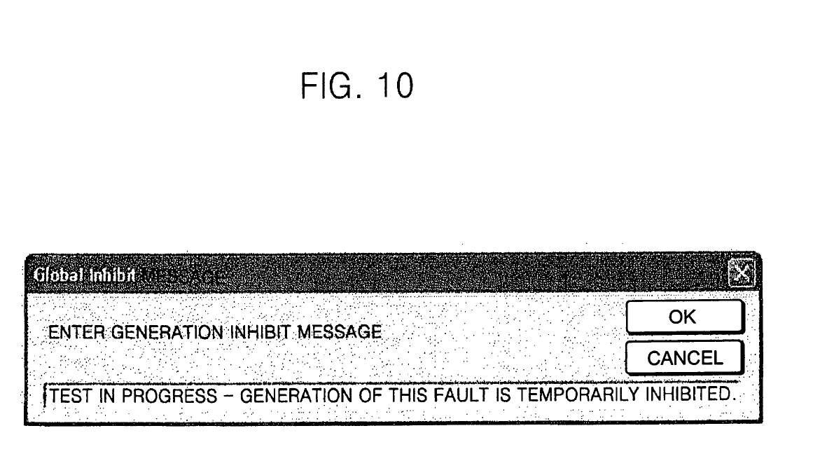

FIG. 10 is a view of a message input window delivering autonomous message generation inhibition in accordance with yet another exemplary embodiment of the present invention.

The network manager can use the GUI of FIG. 9 to issue a command to inhibit the autonomous message from being generated in the global option. In particular, the network manager can sequentially select the NE from menu No. 1, the autonomous event generation event from menu No. 5, the global option from menu No. 3, and the Inhibit from menu No. 4. In this case, the NMS client displays the message input window of FIG. 7.

When the command to stop the autonomous message transmission has been issued in the global option, other NMS clients are also asked whether the autonomous message is to be stopped from being received. In this case, not only the inquiry as to whether the autonomous message is to be stopped from being received but also the reason why the autonomous message is to be stopped from being transmitted are displayed together.

Referring to FIG. 10, a phrase, ‘Test in progress—generation of this Fault is temporarily inhibited’, has been input by the network manager who has stopped the autonomous message in the global option.

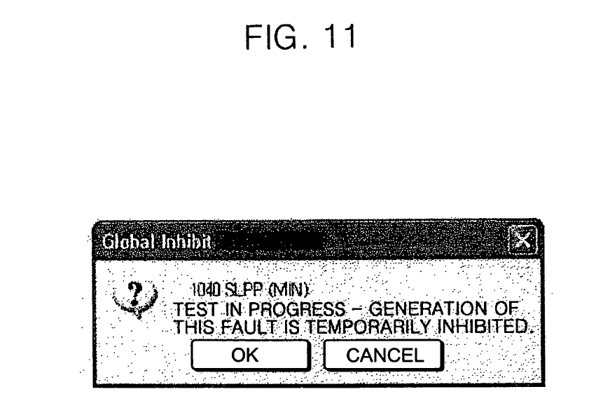

FIG. 11 is a view of a message output window of autonomous message generation inhibition in accordance with yet another exemplary embodiment of the present invention.

During the procedure of FIG. 10, the corresponding NE generates an autonomous event generation inhibition event, and delivers it along with an input message to other NMS clients. The NMS client pops up the message output window asking whether the autonomous message is to be inhibited from being received along with the input message as shown in FIG. 11. Referring to the message output window, character strings such as 1040, SLPP, and (MIN) can be seen. In this case, 1040 indicates a code of the autonomous message. SLPP indicates an autonomous message alarm group, and (MIN) indicates an importance grade. In addition, it can also be seen that the phrase, ‘Test in progress—generation of this Fault is temporarily inhibited’, is displayed together.

As such, the NMS client outputs the reason why the autonomous message has been inhibited from being generated along with the information of the autonomous message event, so that the network manager can easily understand the reason why the autonomous message generation inhibition event has been generated and properly deal with the status.

For example, the TL1 protocol is used for communication between the NMS and the NE of the present invention. However, it is clear that the present invention can also be applied to a SNMP or the like.

According to the management system and method of controlling autonomous message transmission according to the present invention as described above, problems of the conventional art in which a specific autonomous message cannot be transmitted to NMS clients trying to receive the autonomous message, causing a critical error in the network when an arbitrary NMS client issues a command to inhibit the specific autonomous message from being generated, can be overcome. Furthermore, other network managers can easily receive the reason why the autonomous message has been inhibited and determine whether to receive the autonomous message in a convenient and active way.

While the present invention has been described with reference to the exemplary embodiments, it should be understood to those skilled in the art that various other modifications and changes can be provided within the spirit and scope the present invention defined by the following claims.

What is claimed is:

1. A Network Management System (NMS), comprising:
at least one NMS client adapted to carry out network management;
a Network Element (NE) adapted to transmit an autonomous message corresponding to a predetermined event upon the event occurrence; and
an NMS server adapted to store whether receipt of the autonomous message is permitted for each NMS client, and to transmit the autonomous message only to NMS clients permitted receipt of the autonomous message upon receipt of the autonomous message from the NE.

2. The NMS according to claim 1, wherein the NMS server comprises:
a database adapted to store whether receipt of the autonomous message is permitted for each NMS client; and
an autonomous message processing module adapted to retrieve the NMS clients permitted receipt of the autonomous message from the database, and to transmit the autonomous message to the retrieved NMS clients.

3. The NMS according to claim 2, wherein the autonomous message processing module is adapted to extract at least one message characteristic from a code, a severity, and an autonomous message generation element, of the received autonomous message, and to retrieve the NMS clients permitted receipt of the autonomous message having the extracted message characteristic from the database.

4. The NMS according to claim 2, wherein the NMS server further comprises a client management module adapted to update whether the autonomous message stored in the database has been received by a first NMS client upon receiving a local autonomous message transmission control command from the first NMS client.

5. The NMS according to claim 2, wherein the NE comprises an autonomous message event control module adapted to transmit an autonomous message control event to the NMS server, the autonomous message control event requesting the NMS server to query whether a predetermined autonomous message has been received for each NMS client belonging to the network and to obtain a response to the query.

6. The NMS according to claim 5, wherein the NMS server further comprises a client management module adapted to query whether the predetermined autonomous message has been received for each NMS client belonging to the network, and to update whether receipt of the autonomous message stored in the database is permitted for each NMS client according to the response to the query.

7. The NMS according to claim 2, wherein the NMS server further comprises an account management module adapted to add, modify, and erase an account of the NMS client controlled by the NMS server.

8. A Network Management System (NMS) client, comprising:
an interface adapted to display network resource status information, and to receive a control command from a network manager;
an autonomous message display module adapted to control the interface to display an autonomous message upon receiving the autonomous message from an NMS server; and
an autonomous message control event module adapted to receive whether receipt of a predetermined autonomous message is permitted from the network manager upon receiving the predetermined autonomous message control event from the NMS server, and to respond to the NMS server with the received result.

9. A Network Management System (NMS) server, comprising:
a database adapted to store whether an autonomous message is to be received for at least one NMS client belonging to a network; and
an autonomous message processing module adapted to retrieve the NMS client permitted receipt of the autonomous message transmitted from a Network Element (NE) from the database, and to transmit the autonomous message only to the retrieved NMS client.

10. The NMS server according to claim 9, further comprising a client management module adapted to update whether an autonomous message stored in the database is to be received by the first NMS client upon receiving a local autonomous message transmission control command from a first NMS client.

11. The NMS server according to claim 9, further comprising a client management module adapted to query whether a predetermined autonomous message is to be received for each NMS client belonging to the network, and to update whether the autonomous message is to be received for each NMS client in accordance with a response to the query.

12. The NMS server according to claim 1, wherein the client management module is adapted to query whether the autonomous message is to be received for each NMS client belonging to the network upon receiving an autonomous message control event from either the NE or an NMS client belonging to the network.

13. A Network Element (NE), comprising:
an autonomous message generation module adapted to transmit an autonomous message corresponding to a predetermined event to a Network Management System (NMS) server upon the event occurring; and
an autonomous message event control module adapted to transmit an autonomous message control event to the NMS server, the autonomous message event querying whether the predetermined autonomous message is to be received for each NMS client belonging to the network and getting a response to the query.

14. A network management method comprising:
a Network Management System (NMS) server storing in a database whether an autonomous message is to be received for at least one NMS client belonging to a network;
a Network Element (NE) transmitting the autonomous message corresponding to a predetermined event to the NMS server upon the event occurring; and
the NMS server receiving the autonomous message, retrieving the NMS clients permitted receipt of the autonomous message from the database, and transmitting the autonomous message to the retrieved NMS clients.

15. The network management method according to claim 14, further comprising the NMS server updating whether the autonomous message stored in the database is to be received by a first NMS client upon receiving a local autonomous message transmission control command from the first NMS client.

16. The network management method according to claim 14, further comprising:
the NMS server querying whether the autonomous message is to be received for each NMS client upon receiving a predetermined autonomous message control event; and
receiving a response to the query from each NMS client, and updating whether the autonomous message stored in the database is to be received for each NMS client based on the response.

17. The network management method according to claim 16, wherein the NMS server queries whether a predetermined autonomous message is to be received for each NMS client belonging to the network upon receiving an autonomous message control event from either the NE or an NMS client belonging to the network.

18. The network management method according to claim 14, wherein retrieving the management client permitted receipt of the autonomous message comprises:
extracting at least one message characteristic from a code, a severity, and an autonomous message generation element, of the received autonomous message; and
retrieving the NMS clients allowed the extracted message characteristic to be received in the database for each message characteristic.
